(19) United States
(12) Patent Application Publication
(10) Pub. No.: US 2006/0109414 A1
(43) Pub. Date: May 25, 2006

(54) Flexible liquid crystal display panel device and manufacturing method therefor

(76) Inventors: Chi-Chang Liao, Tai Nan City (TW); Lung-Pin Hsin, Tai Chung City (TW); Jau-Min Ding, Taipei City (TW)

Correspondence Address: RABIN & BERDO, P.C.;Suite 500, 1101 14 Street, N.W., Washington, DC, 20005, US

(21) Appl. No.: 11/282,485

(22) Filed: Nov. 21, 2005

(30) Foreign Application Priority Data
Nov. 19, 2004 (TW) 93135765

(51) Int. Cl. G02F 1/1333

(52) U.S. Cl. 349/158

(57) ABSTRACT

A manufacturing process for flexible LCD panel has steps of disposing a first flexible substrate on a hard carrying base, forming an electrode pattern layer on said first flexible substrate, spreading an alignment layer on said electrode pattern layer, printing plural miniature structures on said alignment layer, curing one resin of the miniature to form semi-solid structures, forming a liquid crystal layer within the semi-interpenetrating polymer network miniature structure, mounting and controlled-pressing a second flexible substrate on the semi-interpenetrating polymer network miniature structure, and curing the second resin of miniature structure to form interpenetrating polymer network miniature structure and detaching said hard carrying base so as to complete the flexible LCD panel. Through the present invention, the process for manufacturing the flexible liquid crystal display is simplified in that the cell gap controlling, substrates adhering, and assembling can be accomplished by utilizing a two-step polymerization process.

### BACKGROUND OF THE INVENTION

1. Field of the Invention

The present invention is related to a flexible liquid crystal display (LCD) panel device and a manufacturing method therefor, and more particularly, to a device that can utilize a printing process for printing a micro-miniature structure on a flexible substrate and then utilize two step polymerization process including a UV exposure and a heating to accurately controlling the cell gap and adhering an upper and a lower substrate simultaneously while assembling, in which the micro-miniature structure is composed of a kind of interpenetrating polymer network based on UV-curing polymer and thermosetting polymer. That is, the process for manufacturing the flexible liquid crystal display is simplified.

2. Description of Related Art

The image quality of the LCD may be influenced by a cell gap between two substrates at different levels, with different employed displaying modules. Overall, however, the control of the uniformity of the cell gap is still a very important technology in the manufacturing process for the LCD. Conventionally, lots of glass balls or glass fibers having uniform diameters, known as spacers, are disposed between the upper and the lower substrates. The upper and the lower substrates are then pressed together for adhering through the frame adhesive. However, if the substrates are replaced by a flexible material, the conventional spacer method is no longer suitable because it is difficult to accurately control the density and the position of spacers. In addition, when the panel is bent through an external force, the upper and the lower substrates easily burst apart due to no adhesion force in the display region. Therefore, a more efficient method for the flexible substrate procedure to support and control the cell gap between the upper and the lower substrates and simultaneously to get the substrates adhered together is necessary.

Several conventional methods have been developed for satisfying the demands stated above. Koninklijke Philips Electronics, N.V. has proposed a novel single substrate display through using a Phase Separated Composite Organic Film (PSCOF). The process is based on coating the monomer/liquid crystal mixture on a plastic substrate. UV light illumination was then applied to cure the resin to form a polymer film covering the liquid crystal molecules on a plastic substrate and to form simultaneously a polymer wall for supporting and adhering two substrates. Furthermore, in U.S. Pat. No. 6,672,921, “Manufacturing Process for Electronphoretic Display”, SiPix Imaging, Inc. discloses a manufacturing process and apparatus for a Micro-cup array. Reference is made to FIG. 1, showing a schematic depiction of the electrophoretic display. The method for manufacturing the electrophoretic display in this patent is to fabricate a filling material for the electrophoretic display; when forming the micro-cup, a male mode having an appropriate surface structure is used as a rolling wheel, and when a substrate covered by a resin passes the rolling wheel, it will cure the resin to form the desired micro-cup through heating or radiation.

As to the single substrate display technology proposed by Koninklijke Philips Electronics, N.V., the morphology of the upper polymer film is not easily controlled and its structural strength to inhibit the permeability of oxygen and water vapor is insufficient. Moreover, although the method disclosed by SiPix Imaging, Inc. is advantageously suitable for a continuous manufacturing procedure, a fast production speed, and a low cost, when used in the LCD manufacturing procedure, the formation of a uniform-aligned alignment layer on the micro-cup has already a difficulty. Thus, this procedure is also not completely conformable.

### SUMMARY OF THE INVENTION

For eliminating the defects in the prior arts, the applicant proposes a flexible liquid crystal display panel device and a manufacturing method therefor.

The main object of the present invention is to provide a device that can utilize a printing process for printing a micro-miniature structure on a flexible substrate and then utilize two step polymerization process including a UV exposure and a heating to accurately controlling the cell gap and adhering an upper and a lower substrate simultaneously while assembling, in which the micro-miniature structure is composed of a kind of interpenetrating polymer network based on UV-curing polymer and thermosetting polymer. That is, the process for manufacturing the flexible liquid crystal display is simplified.

For achieving the object above, the present invention provides a manufacturing process for a flexible LCD panel, including steps of disposing a first flexible substrate on a hard carrying base, forming an electrode pattern layer on the first flexible substrate, spreading an alignment layer on the electrode pattern layer, printing plural miniature structures on the alignment layer, curing one resin of the miniature for forming the semi-interpenetrating polymer network miniature structures via a UV exposure or a heating treatment, forming a liquid crystal layer between the semi-interpenetrating polymer network miniature structures, mounting and controlled-pressing a second flexible substrate onto the semi-interpenetrating polymer network miniature structures, and curing second resin of the miniature for further forming the interpenetrating polymer network miniature structures through UV exposure or heating treatment and detaching the hard carrying base so as to complete the flexible LCD panel.

The present invention further provides a flexible LCD panel device formed by the above-described process.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a schematic view showing an electrophoretic display in the prior arts;

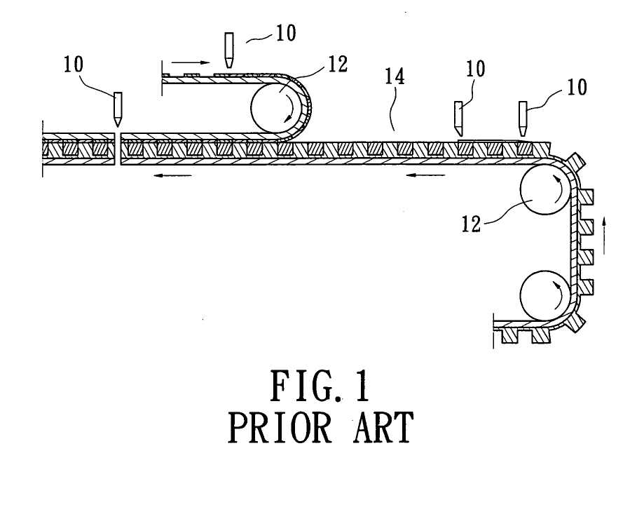

FIGS. 2A to 2I are schematic views showing a manufacturing process of a flexible LCD panel according to the present invention;

FIG. 2I is a schematic view showing a flexible LCD panel device according to the present invention; and

FIGS. 3A to 3D are schematic views showing the implement for printing miniature structures.

### DETAILED DESCRIPTION OF PREFERRED EMBODIMENTS

The present invention utilizes a printing process for printing a micro-miniature structure on a flexible substrate and then utilizes two step polymerization process including a UV exposure and a heating to accurately controlling the cell gap and adhering an upper and a lower substrate simultaneously while assembling, in which the micro-miniature structure is composed of a kind of interpenetrating polymer network based on UV-curing polymer and thermosetting polymer. That is, the process for manufacturing the flexible liquid crystal display is simplified.

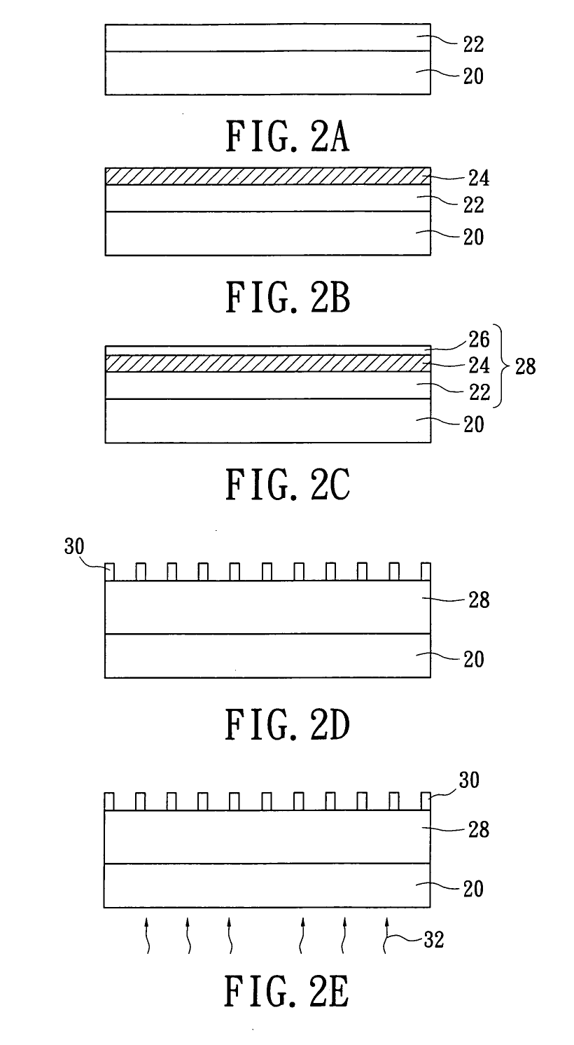

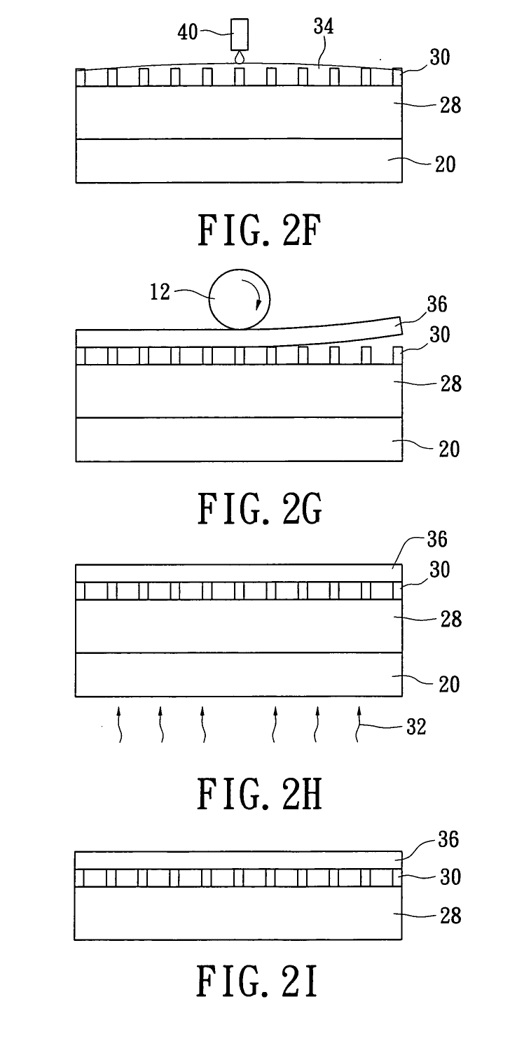

Reference is made to FIGS. 2A to 2G showing schematic views of manufacturing process of a flexible liquid crystal display panel according to the present invention. First, a first flexible substrate 18 is made. In FIG. 2A, a first flexible material 22 is disposed on a hard carrying base 20. The flexible material is a plastic substrate and the material of the plastic substrate can be a polyesterurethane (PET), a polyethersulfone (PES), a heat-resistant and transparent resin (e.g., arton), a photo-curable resin (e.g., acrylic resin) or a thermosetting resin (e.g., epoxy).

In FIG. 2B, an electrode pattern layer 24 is formed on the first flexible material 22. The material of the electrode pattern layer is a conductive film and the conductive film can be made of an inorganic conductive material, such as a copper film, a silver film, a chromium film or ITO, or made of an organic conductive material, such as, for example, Polyethylene-dioxithiophene (PEDOT). In FIG. 2C, an alignment layer 26 may be spread on the electrode pattern layer 24. The material of the alignment layer can be a polyimide, a polyamic acid or photo-aligned material. It should be noted that this alignment layer is not necessary and thus should be matched to the display module.

In FIG. 2D, plural miniature structures 30 which composed of UV-curable resin and thermo-curable resin mixture are printed on the first flexible substrate 28. The first flexible substrate 28 is composed of the flexible material 22, the electrode pattern layer 24, and the alignment layer 26. In FIG. 2E, one resin is polymerized by using a heating method or a UV exposure to form the semi-interpenetrating polymer network miniature structures. Here, it is preferable to use UV exposure. In FIG. 2F, a liquid crystal layer 34 is formed between the semi-interpenetrating polymer network miniature structures 30. In FIG. 2G, a second flexible substrate 36 is controlled to mount and press on the semi-interpenetrating polymer network miniature structures 30. The pressing is controlled by using a rolling wheel. It should be noted that the second flexible substrate 36 may have a flexible material 22, an electrode pattern layer 24 and an optional alignment layer 26 spread on the electrode pattern layer 24, but these are not necessary structures here and should conform to the display module used. Further, the manufacturing process of these layers may be found in FIGS. 2A to 2C, as described above, through detaching the hard carrying base 20. In FIG. 2H, the second resin is polymerized by using a heating method or a UV exposure to form the interpenetrating polymer network miniature structures and get them adhered to the second flexible substrate 36. Here, heating method is preferable. Finally, in FIG. 2I, the hard carrying base is detached to complete the manufacturing process of the flexible LCD panel.

Reference is made to FIG. 2I, showing the schematic view of the complete flexible LCD device according to the present invention. The device includes a first flexible substrate 28, plural miniature structures 30 composed of UV-curable resin and thermal-curable resin mixture printed on the first flexible substrate 28, a liquid crystal layer 34 formed between plural semi-interpenetrating polymer network miniature structures, and a second flexible substrate 36 controlled to mount and press on the semi-interpenetrating polymer network miniature structures. The first flexible substrate includes at least a flexible material 22, an electrode pattern layer 24, and a selectable alignment layer 26 formed on the electrode pattern layer. The plural miniature structures 30 are formed by a contact rolling printing, a contact plate printing, an ink-jet printing or a screen printing. The pressing of the second flexible substrate 36 is controlled by using a rolling wheel and may have a flexible material 22, an electrode pattern layer 24 and an alignment layer 26 spread on the electrode pattern layer 24 through detaching the hard carrying base 20.

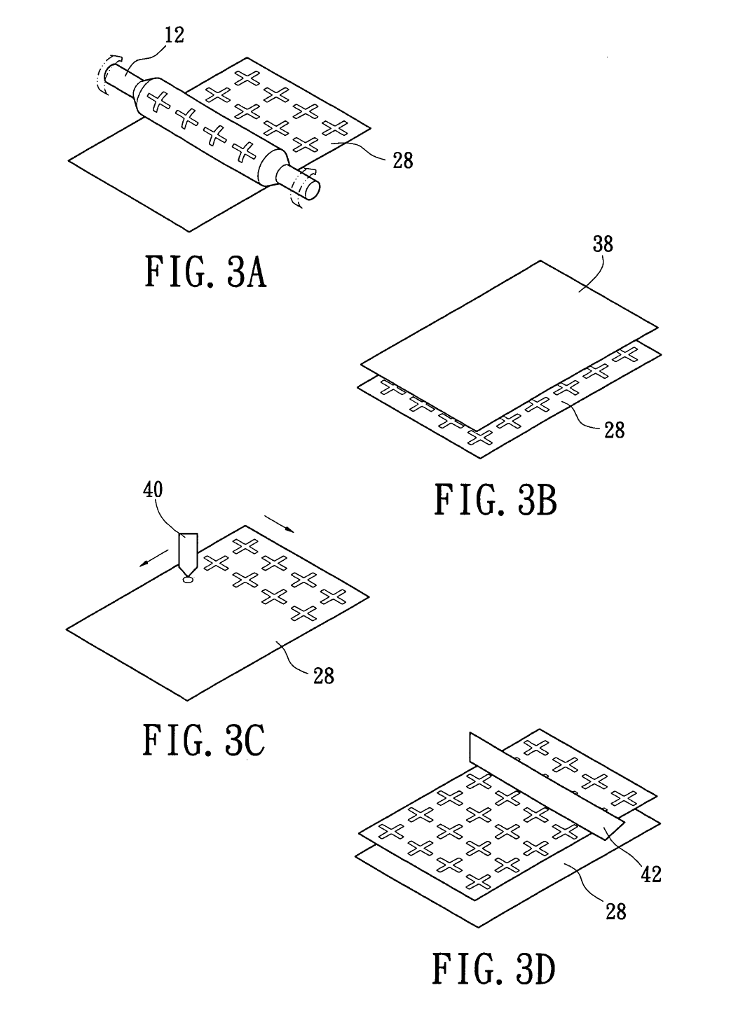

Reference is made to FIGS. 3A to 3D showing schematic views for implement of printing miniature structures. In FIG. 3A, an embodiment of using the contact rolling printing to form plural miniature structures is disclosed, in which an uniform thin film of adhering material is covered on a rolling wheel 12 having spacer patterns, and then printed on the flexible substrate 28. The adhering material is composed of UV-curable resin and thermal-curable resin mixture, and may be further mixed with an appropriate amount of hard spacer. If a module with polarizers is considered, the adhering material may be a block light-absorbing material. Moreover, the patterns printed on the flexible substrate, in addition to the thickness higher than the cell gap, further have hard spacers for supporting. And, the semi-interpenetrating polymer network miniature structures prior to the pressing may maintain the height and shape of the patterns and further prevent a serious flowing without losing adhesive and plasticity. Thus, as pressing, it can be pressed to a desired cell gap and cured.

In FIG. 3B, an embodiment of using the contact plate printing to form plural miniature structures is disclosed, in which an uniform thin film of adhering material is covered on a plate 38 having spacer patterns, and then printed on the flexible substrate 28. The adhering material is composed of UV-curable resin and thermal-curable resin mixture, and may be further mixed with an appropriate amount of hard spacer. If a module with polarizers is considered, the adhering material may be a block light-absorbing material. Moreover, the patterns printed on the flexible substrate, in addition to having a thickness higher than the cell gap, further have hard spacers for support. Additionally, the semi-interpenetrating polymer network miniature structures prior to the pressing may maintain the height and shape of the patterns and further prevent a serious flow without losing adhesive and plasticity. Thus, when pressing, it can be pressed to a desired cell gap and cured.

In FIG. 3C, an embodiment of using the ink-jet printing to form plural miniature structures is disclosed, in which the adhering material composed of UV-curable resin and thermal-curable resin mixture is sprayed by an ink-jetting apparatus 40 so as to paint the designed spacer patterns, and the semi-interpenetrating polymer network miniature structures prior to the pressing may maintain the height and shape of the patterns and further prevent a serious flow without losing adhesion and plasticity. Thus, when pressing, it can be pressed to a desired cell gap and cured.

In FIG. 3D, an embodiment of using the screen printing to form plural miniature structures is disclosed, in which a screen plate 42 having patterns of the miniature structures is formed, and then, the adhering material is transferred and printed on the flexible substrate 28 by screen printing. After removing the screen left followed by using a heating method or a UV exposure, the semi-interpenetrating polymer network miniature structure is performed to maintain the height and shape of the patterns and for further preventing a serious flowing without losing adhesive and plasticity. Thus, when pressing, it can be pressed to a desired cell gap and cured.

In the above-described embodiments for printing miniature structures, when the adhering material is printed on the substrate, a photo-initiated polymerization is first performed to form the semi-interpenetrating polymer network miniature structure for being able to support the shape of the spacer. Then, when assembling, the heating treatment for the non-reacted thermal-curable resin is further polymerized to form the interpenetrating polymer network miniature structure while the substrate is pressed to a desired height so as to achieve the purposes of adhesion and support. Through this method, in addition to convenience, low pollution and high quality reliability of the photo-curable resin, it also has the advantages of the high mechanical strength and adhesion of the thermosetting resin. In addition, the processing method of semi-interpenetrating polymer network miniature structure can avoid the instability of fluid during processing and thus can be mass-produced.

The present invention utilizes a printing process for printing an adhesive adhering material on a flexible substrate to form miniature structures and also utilizes an UV exposure or a heating method while assembling to achieve double functions of adhering and fixing the cell gap between upper and lower substrates, so that the simplify of the process for manufacturing the microminiature structure can be effected.

As can be seen from the above, the present invention, which can exactly solve the defects in the prior arts, is really a product with a highly practical value and also has an increment of efficiency.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A manufacturing process for a flexible liquid crystal display (LCD) panel, comprising steps of:
forming a first flexible substrate;
printing pre-polymer which can be induced to polymerized by two steps to form plural miniature structures on said first flexible substrate;
pre-polymer is polymerized for the first time to form the semi-interpenetrating polymer network miniature structure;
forming a liquid crystal layer within the semi-interpenetrating polymer network miniature structure;
mounting and controlled-pressing a second flexible substrate on the semi-interpenetrating polymer network miniature structure; and
the semi-interpenetrating polymer network miniature structure is polymerized for the second time to form the interpenetrating polymer network miniature structure that is adhered to said second flexible substrate so as to form said flexible LCD panel simultaneously.

2. A manufacturing method as claimed in claim 1, wherein the steps of forming said first flexible substrate further comprise:
disposing a first flexible material on a hard carrying base;
forming an electrode pattern layer on said first flexible material; and
optionally spreading an alignment layer on said electrode pattern layer.

3. A manufacturing method as claimed in claim 2, wherein said first flexible material is a plastic substrate.

4. A manufacturing method as claimed in claim 3, wherein a material of said plastic substrate is a polyesterurethane (PET), a polyethersulfone (PES), a heat-resistant and transparent resin, a photo-curable resin or a thermosetting resin.

5. A manufacturing method as claimed in claim 2, wherein a material of said electrode pattern layer is a conductive film.

6. A manufacturing method as claimed in claim 5, wherein said conductive film is made of an inorganic conductive material or an organic conductive material.

7. A manufacturing method as claimed in claim 6, wherein said inorganic conductive material is a copper film, a silver film, a chromium film or an ITO.

8. A manufacturing method as claimed in claim 6, wherein said organic conductive material is a polyethylene-dioxithiophene (PEDOT).

9. A manufacturing method as claimed in claim 2, wherein a material of said alignment layer is a polyimide, a polyamic acid or a photo-aligned material.

10. A manufacturing method as claimed in claim 1, wherein said step of printing the miniature structures is performed by a contact rolling printing, a contact plate printing, an ink-jet printing or a screen printing.

11. A manufacturing method as claimed in claim 10, wherein said contact rolling printing is performed by covering a carved rolling wheel having spacer patterns with a uniform thin film of adhering material, and then printing said spacer patterns on said flexible substrate.

12. A manufacturing method as claimed in claim 11, wherein said adhering material is composed of UV-curable resin and thermal-curable resin mixture and has an appropriate amount of further mixed hard spacer.

13. A manufacturing method as claimed in claim 11, wherein said adhering material is a block light-absorbing material.

14. A manufacturing method as claimed in claim 10, wherein said contact plate printing is performed by covering a plate wheel having spacer patterns with a uniform thin film of adhering material, and then printing said spacer patterns onto said flexible substrate.

15. A manufacturing method as claimed in claim 10, wherein said ink-jet printing is performed by spraying an adhering material to paint a designed spacer pattern.

16. A manufacturing method as claimed in claim 10, wherein said screen printing is performed by forming a screen plate having patterns of the miniature structures, and then transferring and printing said patterns onto said flexible substrate by screen printing.

17. A manufacturing method as claimed in claim 1, wherein said semi-interpenetrating polymer network miniature structure is formed through curing one resin of printed miniature by heating treatment or a UV exposure.

18. A manufacturing method as claimed in claim 1, wherein the steps to form the said second flexible substrate comprise:
disposing a second flexible material on a hard carrying base;
forming an electrode pattern layer on said second flexible material;
optionally spreading an alignment layer on said electrode pattern layer; and
detaching said hard carrying base.

19. A manufacturing method as claimed in claim 1, wherein the interpenetrating polymer network miniature structure is formed via the said step of mounting and controlled-pressing said second flexible substrate, curing the second resin of the printed miniature such that the cell gap controlling, substrates adhering, and assembling can be accomplished simultaneously.

20. A manufacturing method as claimed in claim 19, wherein said curing is through a heating treatment or a UV exposure.

21. A flexible liquid crystal display (LCD) panel device, comprising:
a first flexible substrate;
plural miniature structures printed on said first flexible substrate;
a liquid crystal layer formed within the semi-interpenetrating polymer network miniature structure; and
a second flexible substrate controlled to mount and press on the semi-interpenetrating polymer network miniature structures.

22. A device as claimed in claim 21, wherein said first flexible substrate comprises a flexible material and an electrode pattern layer, wherein an alignment layer is optionally disposed on said electrode pattern layer.

23. A device as claimed in claim 21, wherein said plural miniature structures are formed by a contact rolling printing, a contact plate printing, an ink-jet printing or a screen printing.

24. A device as claimed in claim 21, wherein said liquid crystal layer is formed by spraying liquid crystal through an ink-jetting apparatus.

25. A device as claimed in claim 21, wherein said second flexible substrate comprises a flexible material, an electrode pattern layer and an alignment layer.

26. A device as claimed in claim 21, wherein said pressing is controlled by a rolling wheel.
